(19) United States
(12) Patent Application Publication
(10) Pub. No.: US 2025/0014351 A1
(43) Pub. Date: Jan. 9, 2025

(54) INFORMATION PRESENTATION COLLECTION SYSTEM, INFORMATION PRESENTATION COLLECTION METHOD, AND RECORD MEDIUM RECORDING INFORMATION PRESENTATION COLLECTION PROGRAM

(71) Applicant: Mitsubishi Electric Corporation, Tokyo (JP)

(72) Inventor: Yasunori TSUBAKI, Tokyo (JP)

(73) Assignee: Mitsubishi Electric Corporation, Tokyo (JP)

(21) Appl. No.: 18/886,235

(22) Filed: Sep. 16, 2024

Related U.S. Application Data
(63) Continuation of application No. PCT/JP2022/019013, filed on Apr. 27, 2022.

(51) Int. Cl. G06V 20/52; G06F 3/14; G06V 40/10

(52) U.S. Cl. CPC G06V 20/53; G06F 3/1423; G06V 40/103

(57) ABSTRACT

An information presentation collection system includes a question display device, a reply candidate display device, a sensor to detect people moving in the passage, and processing circuitry to measure a number of the people moving in a direction towards the reply candidate display device. The processing circuitry repeatedly performs display switching of switching the display positions of the plurality of reply candidates to each other according to a predetermined schedule, counts a total number of people who selected each of the plurality of reply candidates in a plurality of information collection periods based on the number of the people measured in each information collection period from one of the display switchings to the next display switching, and outputs a value based on a ratio regarding a plurality of the total numbers as an evaluation value.

### CROSS-REFERENCE TO RELATED APPLICATION

This application is a continuation application of International Application No. PCT/JP2022/019013 having an international filing date of Apr. 27, 2022.

### BACKGROUND OF THE INVENTION

### 1. Field of the Invention

The present disclosure relates to an information presentation collection system, an information presentation collection method, and an information presentation collection program.

### 2. Description of the Related Art

There has been proposed a system including a display device that displays a question, an input device including an input unit that receives an input of a reply to the question, a recognition device that recognizes people, and a reply collection device that determines a change in moving speed of each of a plurality of moving people and a person who made the input to the input unit based on the result of the recognition of the people and collects replies corresponding to the inputs (see Patent Reference 1, for example). Further, this system classifies no-reply people who did not reply to the question (i.e., people who did not use the input unit) into a group of people who had no interest in the question and a group of people who had an interest in the question but refused to reply based on the presence/absence of a decrease in the moving speed of each person and counts the numbers of the two groups of people.

Patent Reference 1: Japanese Patent Application Publication No. 2016-206692 (see claims 1 and 4, for example).

However, in the above-described conventional system, there is a problem in that accuracy of the determination of the consciousness of each person who passed through the input unit without using the input unit is low.

### SUMMARY OF THE INVENTION

An object of the present disclosure is to collect replies to a question from moving people with high accuracy.

An information presentation collection system in the present disclosure includes a question display device to present a question; a reply candidate display device to display a plurality of reply candidates, as options for a reply to the question, at display positions different from each other in a width direction of a passage; at least one of sensors to detect people moving in the passage and to output a detection signal; and processing circuitry to measure a number of the people moving in a direction towards the reply candidate display device in each of a plurality of regions, which are set by dividing the passage in the width direction of the passage and corresponding respectively to the plurality of reply candidates, based on the detection signal, and to control operation of the information presentation collection system. The processing circuitry repeatedly performs display switching of switching the display positions of the plurality of reply candidates to each other according to a predetermined schedule, counts a total number of people who selected each of the plurality of reply candidates in a plurality of information collection periods based on the number of the people measured in each information collection period from one of the display switchings to the next display switching, and outputs a value based on a ratio regarding a plurality of the total numbers as an evaluation value.

An information presentation collection method in the present disclosure is a method to be executed by an information processing device in an information presentation collection system including a question display device to present a question, a reply candidate display device to display a plurality of reply candidates, as options for a reply to the question, at display positions different from each other in a width direction of a passage, a sensor to detect people moving in the passage and outputs a detection signal, and the information processing device. The method includes measuring a number of the people moving in a direction towards the reply candidate display device in each of a plurality of regions, which are set by dividing the passage in the width direction of the passage and corresponding respectively to the plurality of reply candidates, based on the detection signal; repeatedly performing display switching of switching the display positions of the plurality of reply candidates to each other according to a predetermined schedule; counting a total number of people who selected each of the plurality of reply candidates in a plurality of information collection periods based on the number of the people measured in each information collection period from one of the display switchings to the next display switching; and outputting a value based on a ratio regarding a plurality of the total numbers as an evaluation value.

According to the present disclosure, replies to a question can be collected from moving people with high accuracy.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically showing the configuration of an information presentation collection system according to a first embodiment;

FIG. 2 is a schematic diagram showing an example of the operation of the information presentation collection system in FIG. 1;

FIG. 3 is a schematic diagram showing the example of the operation of the information presentation collection system in FIG. 1;

FIG. 4 is a diagram showing an example of the hardware configuration of an information processing device in FIG. 1;

FIG. 5 is a flowchart showing the operation of the information presentation collection system according to the first embodiment;

FIG. 6 is a block diagram schematically showing the configuration of an information presentation collection system according to a second embodiment;

FIG. 7 is a schematic diagram showing an example of the operation of the information presentation collection system in FIG. 6;

FIG. 8 is a schematic diagram showing the example of the operation of the information presentation collection system in FIG. 6;

FIG. 9 is a block diagram schematically showing the configuration of an information presentation collection system according to a third embodiment;

FIG. 10 is a diagram showing an example of the hardware configuration of a display control device in FIG. 9;

FIG. 11 is a diagram showing an example of the hardware configuration of a measurement device in FIG. 9;

FIG. 12 is a block diagram schematically showing the configuration of an information presentation collection system according to a fourth embodiment;

FIG. 13 is a schematic diagram showing an example of the operation of the information presentation collection system in FIG. 12;

FIG. 14 is a schematic diagram showing the example of the operation of the information presentation collection system in FIG. 12;

FIG. 15 is a block diagram schematically showing the configuration of an information presentation collection system according to a fifth embodiment;

FIG. 16 is a schematic diagram showing an example of the operation of the information presentation collection system in FIG. 15;

FIG. 17 is a schematic diagram showing the example of the operation of the information presentation collection system in FIG. 15;

FIG. 18 is a block diagram schematically showing the configuration of an information presentation collection system according to a sixth embodiment;

FIG. 19 is a schematic diagram showing an example of the operation of the information presentation collection system in FIG. 18;

FIG. 20 is a schematic diagram showing the example of the operation of the information presentation collection system in FIG. 18;

FIG. 21 is a block diagram schematically showing the configuration of an information presentation collection system according to a seventh embodiment;

FIG. 22 is a schematic diagram showing an example of the operation of the information presentation collection system in FIG. 21;

FIG. 23 is a schematic diagram showing the example of the operation of the information presentation collection system in FIG. 21;

FIG. 24 is a block diagram schematically showing the configuration of an information presentation collection system according to an eighth embodiment;

FIG. 25 is a schematic diagram showing an example of the operation of the information presentation collection system in FIG. 24;

FIG. 26 is a block diagram schematically showing the configuration of an information presentation collection system according to a ninth embodiment;

FIG. 27 is a schematic diagram showing an example of the operation of the information presentation collection system in FIG. 26;

FIG. 28 is a block diagram schematically showing the configuration of an information presentation collection system according to a tenth embodiment;

FIG. 29 is a schematic diagram showing an example of the operation of the information presentation collection system in FIG. 28; and

FIG. 30 is a flowchart showing the operation of an information presentation collection system in a modification.

### DETAILED DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications will become apparent to those skilled in the art from the detailed description.

An information presentation collection system, an information presentation collection method and an information presentation collection program according to each embodiment will be described below with reference to the drawings. The following embodiments are just examples and it is possible to appropriately combine embodiments and appropriately modify each embodiment.

### First Embodiment

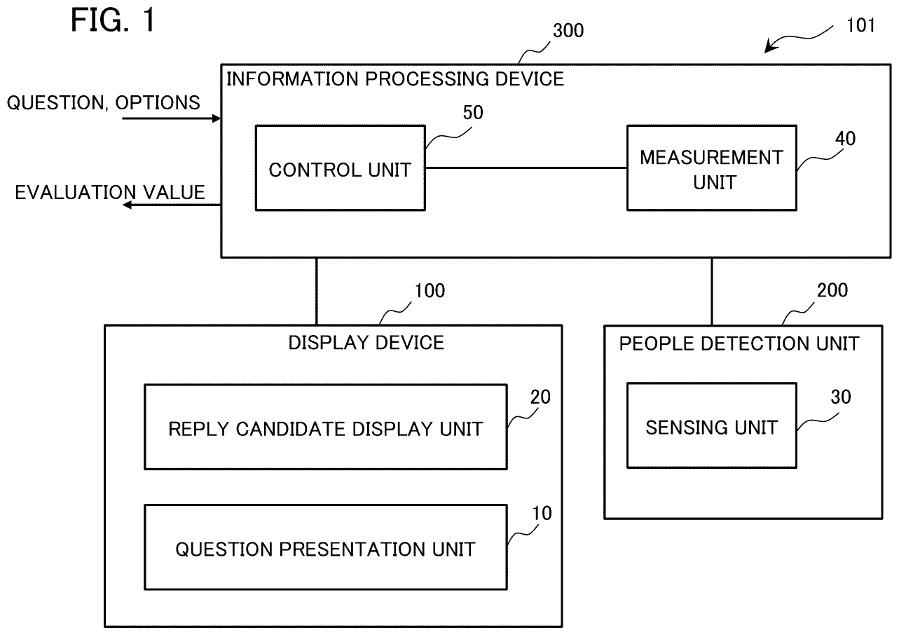

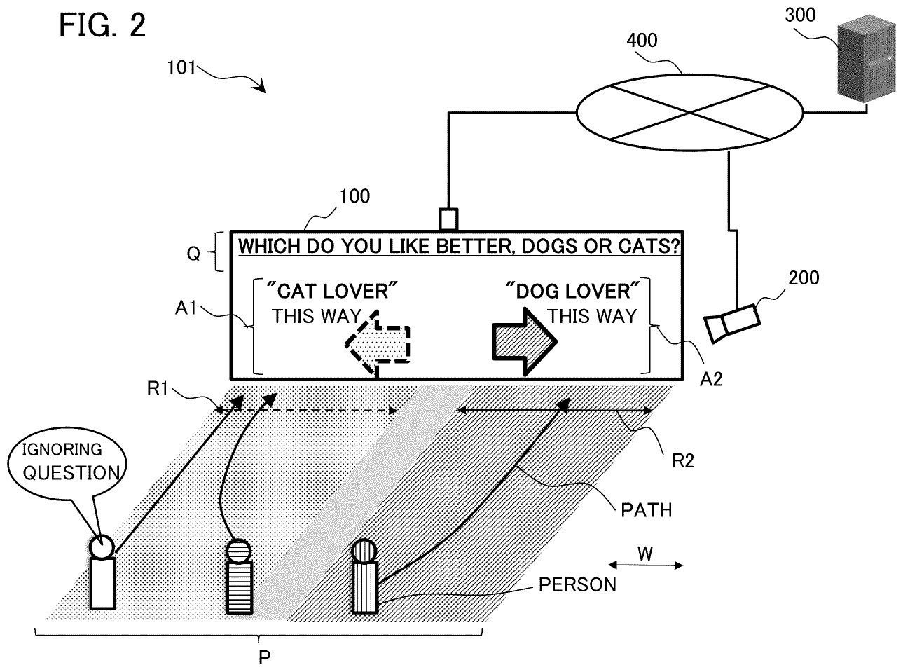

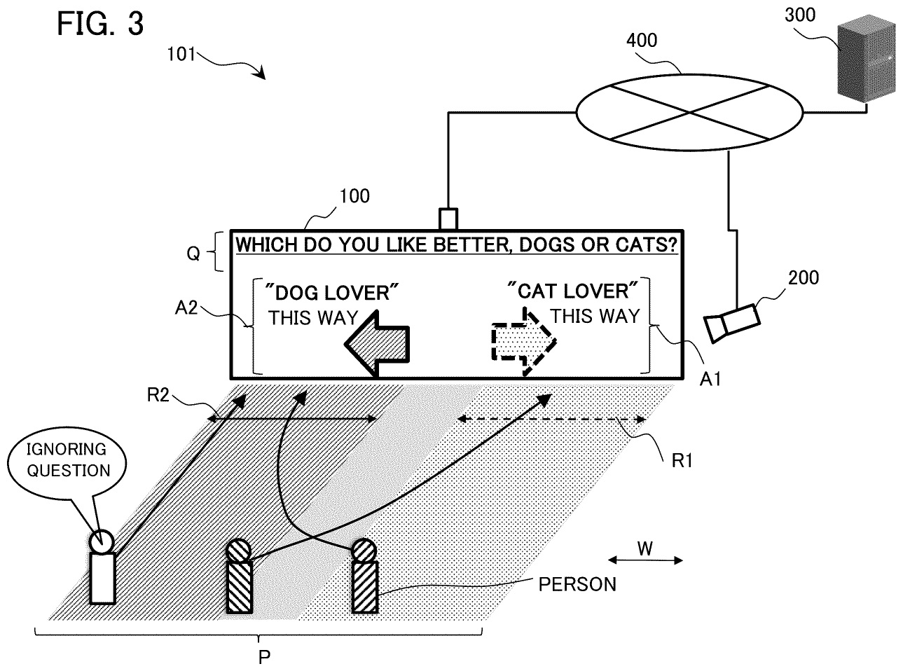

FIG. 1 is a block diagram schematically showing the configuration of an information presentation collection system 101 according to a first embodiment. FIG. 2 and FIG. 3 are schematic diagrams showing an example of the operation of the information presentation collection system 101. The information presentation collection system 101 is a system capable of executing an information presentation collection method according to the first embodiment.

The information presentation collection system 101 includes a display device 100 as an information presentation means that presents information to people (e.g., passersby) by means of an image (or sound or both of image and sound), a people detection unit 200 for detecting people, and an information processing device 300 such as a server (e.g., a computer or a set of computers) on a network 400.

The display device 100 includes, for example, a liquid crystal display placed on a floor surface of a passage P, arranged in an upper part of the passage P (at a position higher than the body height of people), or arranged to form part of the floor surface of the passage P. The display device 100 can also be a device of a different type, such as a projector that projects an image onto the floor surface of the passage P or the like or a floating image display device that displays an image in a space over the passage P. In the first embodiment, the display device 100 includes a question presentation unit (i.e., question display device) 10 that presents a question Q and a reply candidate display unit (i.e., reply candidate display device) 20 that displays a plurality of reply candidates A1, A2, as options for the reply to the question, at display positions different from each other in a width direction W of the passage P. In the first embodiment, the question Q and two reply candidates A1, A2 are displayed at positions different from each other by a single display device 100. However, the number of display devices 100 can also be two or more. Further, the number of reply candidates can also be three or more.

The people detection unit 200 includes a sensing unit 30 (i.e., a sensor) that detects people moving in the passage P and outputs a detection signal. The sensing unit 30 includes, for example, a camera as an image capturing device, an object sensor that detects objects, or both of the camera and the object sensor (i.e., at least one of the camera and the object sensor). The people detection unit 200 may include an information processing unit that processes image data or sensing data obtained by the sensing unit 30 (e.g., executing processing of determining a moving direction of each person, processing of counting the number of people, or the like).

The information processing device 300 is a computer, for example. The information processing device 300 is capable of executing an information presentation collection program according to the first embodiment. The information processing device 300 includes a measurement unit 40 and a control unit 50 that controls the operation of the entire system.

The measurement unit 40 measures the number of people moving in a direction towards the reply candidate display unit 20 in each of a plurality of regions R1, R2, which are set by dividing the passage P in the width direction W of the passage P and corresponding respectively to the plurality of reply candidates A1, A2, based on the detection signal (e.g., video signal) from the sensing unit 30.

The control unit 50 repeatedly performs display switching of switching the display positions of the plurality of reply candidates A1, A2 to each other according to a predetermined schedule. The state of the display switching of switching the display positions of two reply candidates A1 and A2 to each other is shown in FIG. 2 and FIG. 3, for example. FIG. 2 shows a state in which the question Q is “WHICH DO YOU LIKE BETTER, DOGS OR CATS?” for guiding people selecting the reply candidate A1 “CAT LOVER” to the region R1 on the left side and guiding people selecting the reply candidate A2 “DOG LOVER” to the region R2 on the right side. FIG. 3 shows a state in which the question Q is “WHICH DO YOU LIKE BETTER, DOGS OR CATS?” for guiding people selecting the reply candidate Al “DOG LOVER” to the region R2 on the left side and guiding people selecting the reply candidate A2 “CAT LOVER” to the region R1 on the right side. In the predetermined schedule, the display state of the display device 100 is switched each time a predetermined time (referred to also as an “information collection period”) elapses, for example. In the display switching, the switching from the state of FIG. 2 to the state of FIG. 3 and the switching from the state of FIG. 3 to the state of FIG. 2 are performed alternately and repeatedly. By the display switching, influence of people passing through the region R1 or R2 while ignoring the question on an evaluation value can be reduced.

The control unit 50 counts the total numbers N1, N2 of people who selected each of the plurality of reply candidates A1, A2 in a plurality of information collection periods based on the number of people measured in each information collection period from one of the display switchings to the next display switching. That is, the control unit 50 repeatedly performs the switching between the state of FIG. 2 and the state of FIG. 3, obtains the total number N1 of the number of people who selected CAT LOVER in the state shown in FIG. 2 and the number of people who selected CAT LOVER in the state shown in FIG. 3, and obtains the total number N2 of the number of people who selected DOG LOVER in the state shown in FIG. 2 and the number of people who selected DOG LOVER in the state shown in FIG. 3. Then, the control unit 50 outputs a value based on the ratio between the total number N1 of cat lovers and the total number N2 of dog lovers as the evaluation value (i.e., evaluation result).

Among the people moving in the passage P, there exist people passing through the region R1 or R2 while ignoring the question Q (including people who do not notice the question Q). Further, in FIG. 2, the ratio of people passing through the region R1 while ignoring the question Q and the ratio of people passing through the region R2 while ignoring the question Q can vary depending on the situation in the passage P (e.g., a situation in which there is a shop on the left side of the passage P and there is a driveway on the right side of the passage P). Therefore, suppose that the total numbers N1 and N2 of the selectors are obtained only in the display state of FIG. 2 without performing the display switching between the display state of FIG. 2 and the display state of FIG. 3, the number of people passing through the region R1 while ignoring the question Q and the number of people passing through the region R2 while ignoring the question Q can differ greatly from each other depending on the situation in the passage P. Thus, the accuracy of the evaluation value based on the ratio between the total numbers N1 and N2 of the selectors is considered to be low. Therefore, in the first embodiment, the control unit 50 switches the display state of the display device 100 between the display states shown in FIG. 2 and FIG. 3, according to the predetermined schedule. By this method, the influence of the number of people passing through the region R1 while ignoring the question Q and the number of people passing through the region R2 while ignoring the question Q on the evaluation value based on the ratio between the total number N1 and the total number N2 of the selectors can be reduced, and the accuracy of the evaluation value based on the ratio between the total numbers N1 and N2 of the selectors can be increased.

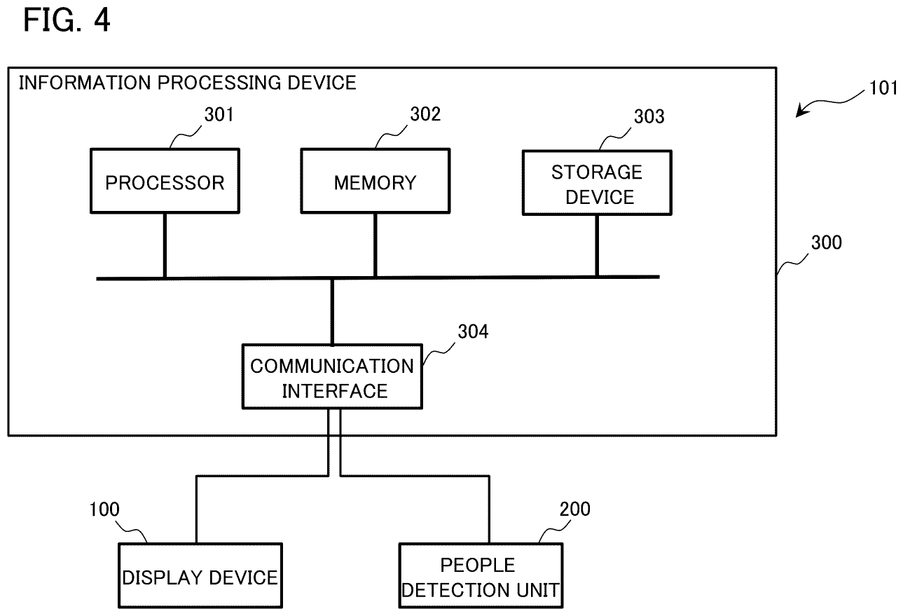

FIG. 4 is a diagram showing an example of the hardware configuration of the information processing device 300 in FIG. 1. The information processing device 300 includes a processor 301 and a memory 302 as a volatile storage device. The information processing device 300 includes a nonvolatile storage device 303 such as a hard disk drive (HDD) or a solid state drive (SSD) and a communication interface 304 that executes communication with external devices. The memory 302 is, for example, a semiconductor memory such as a RAM (Random Access Memory). The information presentation collection program as a software program is stored in the memory 302. The information presentation collection program is provided to the information processing device 300 in a state of having been stored in a record medium (or a storage medium) recording information such as a magnetic disk, an optical disc or a semiconductor memory, or via a communication line. The measurement unit 40 and the control unit 50 in FIG. 1 may be formed by the processor 301 executing the information presentation collection program.

The functions of the information processing device 300 may be implemented by processing circuitry. The processing circuitry can be either dedicated hardware or the processor 301 executing a program stored in the memory 302 as a record medium (i.e., storage medium). The record medium is a non-transitory computer-readable record (i.e., storage) medium storing a program such as the information presentation collection program. The processor 301 can be any one of a processing device, an arithmetic device, a microprocessor, a microcomputer and a DSP (Digital Signal Processor). In the case where the processing circuitry is dedicated hardware, the processing circuitry is an ASIC (Application Specific Integrated Circuit), an FPGA (Field-Programmable Gate Array) or the like, for example.

It is also possible to implement part of the information processing device 300 by dedicated hardware and other part of the information processing device 300 by software or firmware. As above, the processing circuitry is capable of implementing the above-described functions by hardware, software, firmware, or a combination of some of these means.

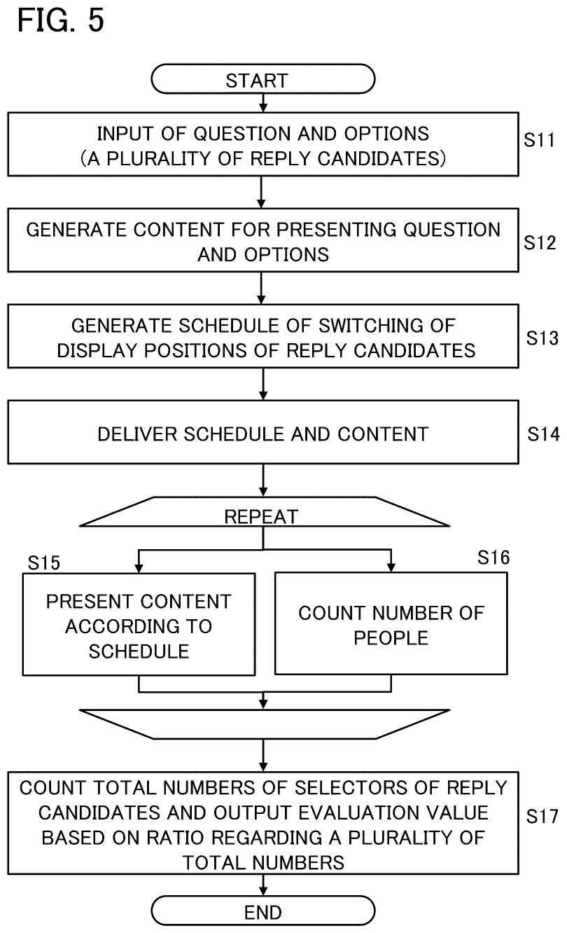

FIG. 5 is a flowchart showing the operation of the information presentation collection system 101. First, the information processing device 300 receives the input of the question Q and the plurality of reply candidates A1, A2 as the options for the reply to the question Q (step S11) and generates content for presenting the question Q and the options (step S12). Subsequently, the information processing device 300 generates the schedule of the switching of the display positions of the reply candidates A1, A2 (step S13) and delivers the generated content and schedule (step S14).

The display device 100 displays the question Q and the reply candidates A1, A2 according to the received content and switches the display positions of the reply candidates A1, A2 (the positions of the regions R1 and R2 at the same time) according to the received schedule (step S15). Further, the information processing device 300 counts the number of people passing through the region R1 and the number of people passing through the region R2 based on the detection signal from the sensing unit 30 (step S16). The processing in the steps S15 and S16 is executed repeatedly during the plurality of information collection periods specified by the schedule.

Subsequently, the information processing device 300 counts the total numbers N1, N2 of the selectors of the reply candidates A1, A2 and outputs the value based on the ratio regarding the plurality of total numbers N1, N2 as the evaluation value (step S17).

As described above, according to the first embodiment, by removing the influence of the people ignoring the question Q existing in a plurality of passersby, it is possible to obtain a highly accurate evaluation result in regard to the passersby's actions of replying to the question Q.

### Second Embodiment

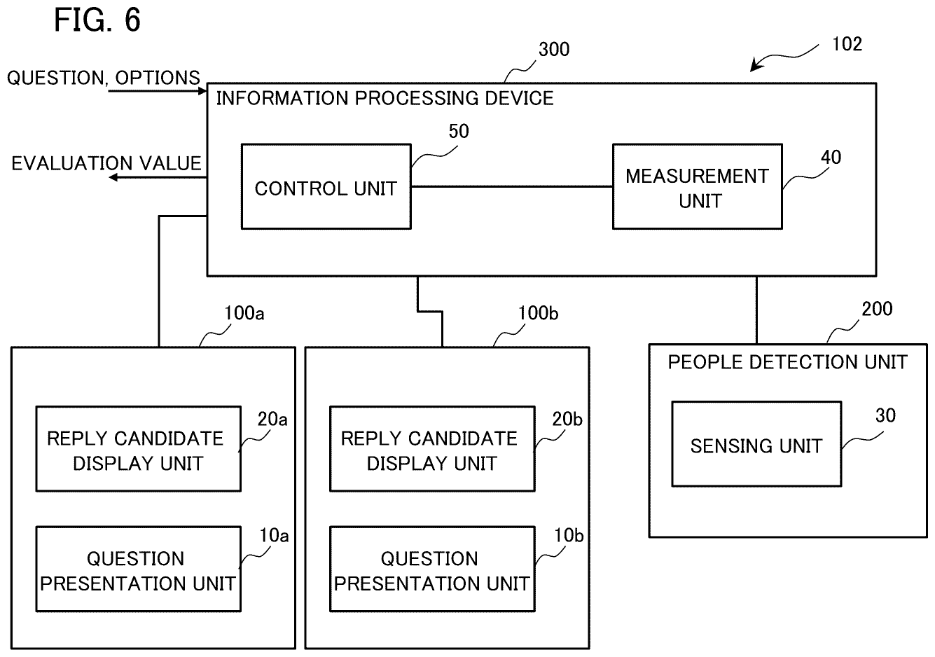

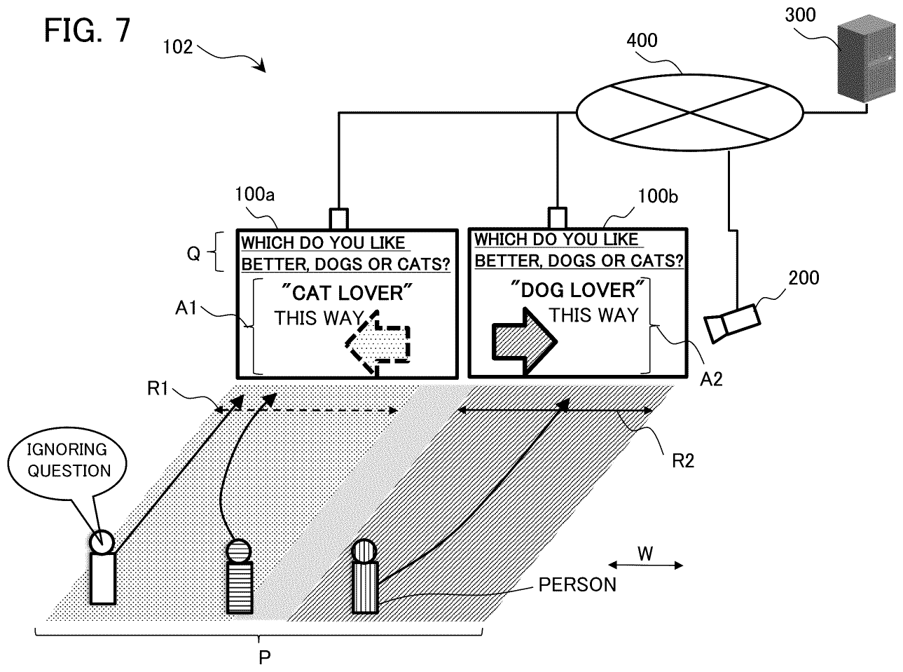

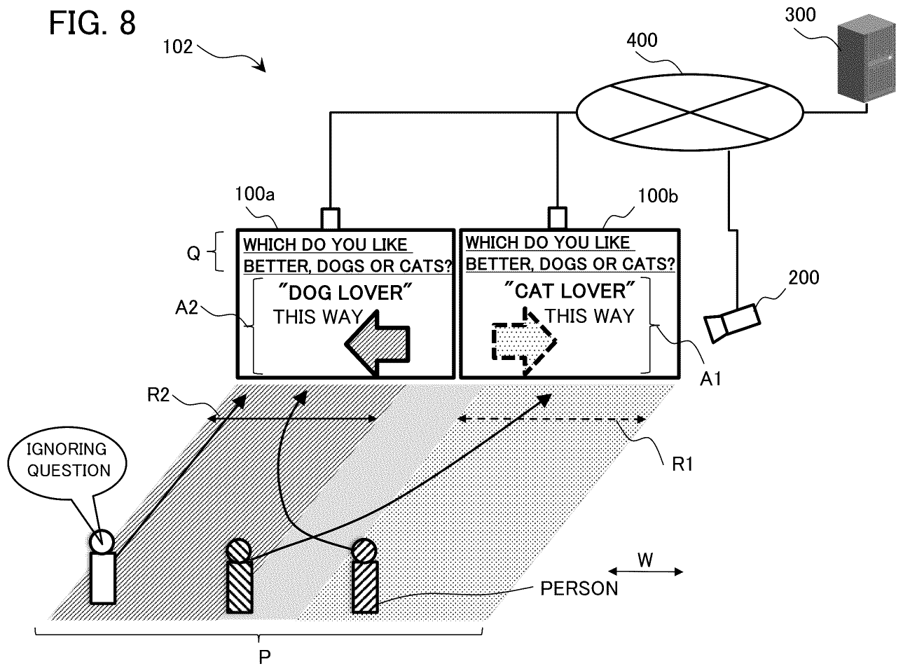

FIG. 6 is a block diagram schematically showing the configuration of an information presentation collection system 102 according to a second embodiment. In FIG. 6, each component identical or corresponding to a component shown in FIG. 1 (the first embodiment) is assigned the same reference character as in FIG. 1. FIG. 7 and FIG. 8 are schematic diagrams showing an example of the operation of the information presentation collection system 102. In FIG. 7 and FIG. 8, each component identical or corresponding to a component shown in FIG. 2 or FIG. 3 (the first embodiment) is assigned the same reference character as in FIG. 2 or FIG. 3.

The information presentation collection system 102 includes a plurality of display devices 100a, 100b. The display device 100a includes a question presentation unit 10a that presents (e.g., displays) a question Q and a reply candidate display unit 20a that displays a reply candidate. The display device 100b includes a question presentation unit 10b that presents (e.g., displays) a question Q and a reply candidate display unit 20b that displays a reply candidate. The number of display devices is not limited to two.

As shown in FIG. 7 and FIG. 8, the information presentation collection system 102 includes the display devices 100a, 100b, and the display devices 100a, 100b display the question Q. The display devices 100a, 100b respectively display the reply candidates A1, A2 in the state of FIG. 7, and the display devices 100a, 100b respectively display the reply candidates A2, A1 in the state of FIG. 8.

According to the second embodiment, the accuracy of the evaluation result in regard to the passersby's replies to the question Q can be increased similarly to the first embodiment. Except for the above-described features, the information presentation collection system 102 is the same as the information presentation collection system 101.

### Third Embodiment

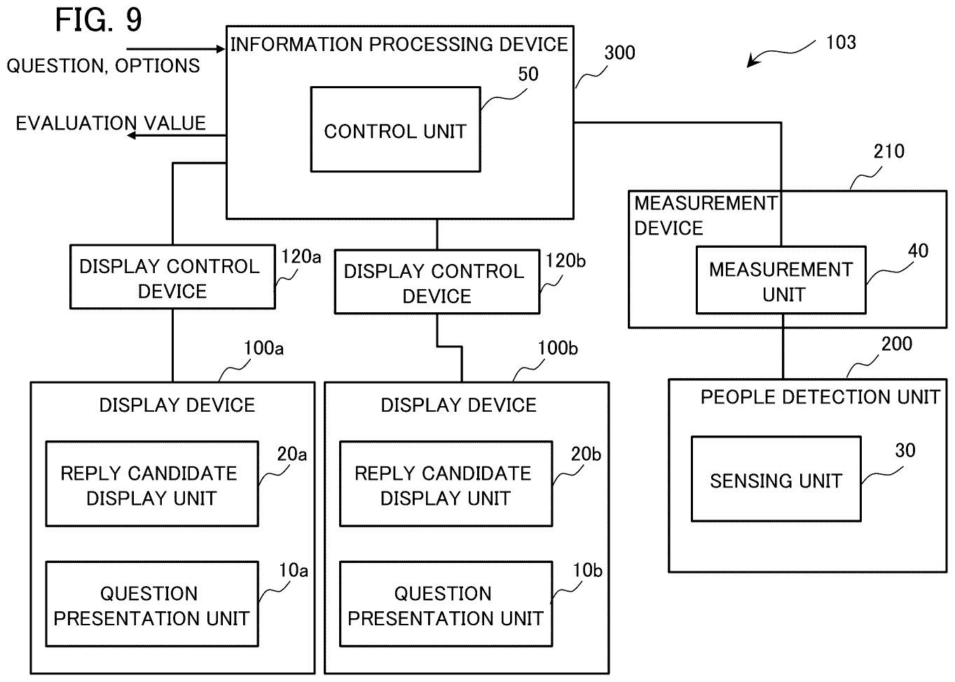

FIG. 9 is a block diagram schematically showing the configuration of an information presentation collection system 103 according to a third embodiment. In FIG. 9, each component identical or corresponding to a component shown in FIG. 6 (the second embodiment) is assigned the same reference character as in FIG. 6. The operation of the information presentation collection system 103 is similar to the operation in FIG. 7 and FIG. 8 (the second embodiment) shown as an example of the operation of the information presentation collection system 102.

The information presentation collection system 103 differs from the information presentation collection system 102 in that a display control device 120a that controls the display operation of the display device 100a, a display control device 120b that controls the display operation of the display device 100b, and a measurement device 210 that executes a people count measurement process based on the output signal from the sensing unit 30 of the people detection unit 200 are provided separately from the information processing device 300. For example, the display control device 120a, the display control device 120b and the measurement device 210 are provided in the passage P similarly to the display device 100a, the display device 100b and the people detection unit 200. The display control device 120a, the display control device 120b and the measurement device 210 may also be provided respectively inside the display device 100a, the display device 100b and the people detection unit 200.

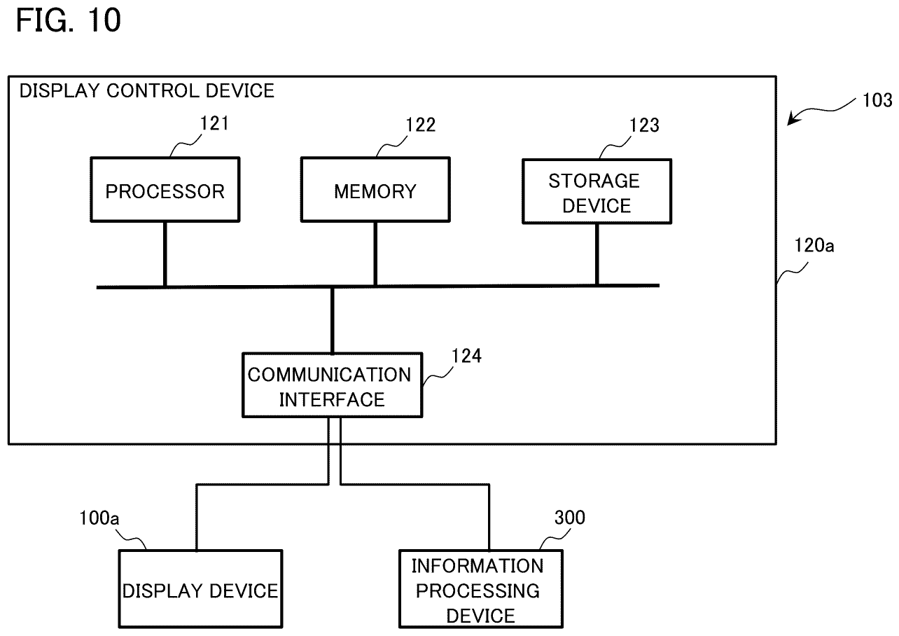

FIG. 10 is a diagram showing an example of the hardware configuration of the display control device 120a in FIG. 9. The display control device 120a includes a processor 121, a memory 122 as a volatile storage device, and a communication interface 124 that executes communication with external devices. The processor 121 may include a GPU (Graphics Processing Unit) in addition to a CPU (Central Processing Unit). The display control device 120a may include a nonvolatile storage device 123 such as an HDD or an SSD. The display control device 120b has the same configuration as the display control device 120a.

The display control devices 120a and 120b execute, for example, the process of generating the content for presenting the question Q and the options and the process of generating the schedule of the switching of the display positions of the reply candidates A1, A2.

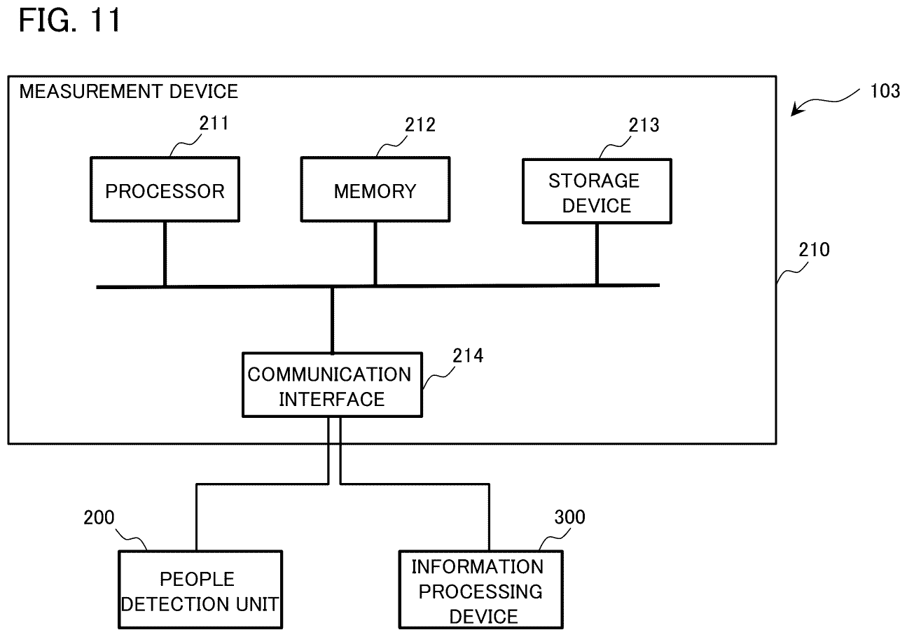

FIG. 11 is a diagram showing an example of the hardware configuration of the measurement device 210 in FIG. 9. The measurement device 210 includes a processor 211, a memory 212 as a volatile storage device, and a communication interface 214 that executes communication with external devices. The measurement device 210 may include a nonvolatile storage device 213 such as an HDD or an SSD.

The measurement device 210 executes the process of counting the number of people passing through the region R1 and the number of people passing through the region R2 based on the detection signal from the sensing unit 30. This configuration eliminates the need to transmit video data or sensor data to the information processing device 300.

According to the third embodiment, the accuracy of the evaluation result in regard to the passersby's replies to the question Q can be increased similarly to the second embodiment. Except for the above-described features, the information presentation collection system 103 is the same as the information presentation collection system 102.

### Fourth Embodiment

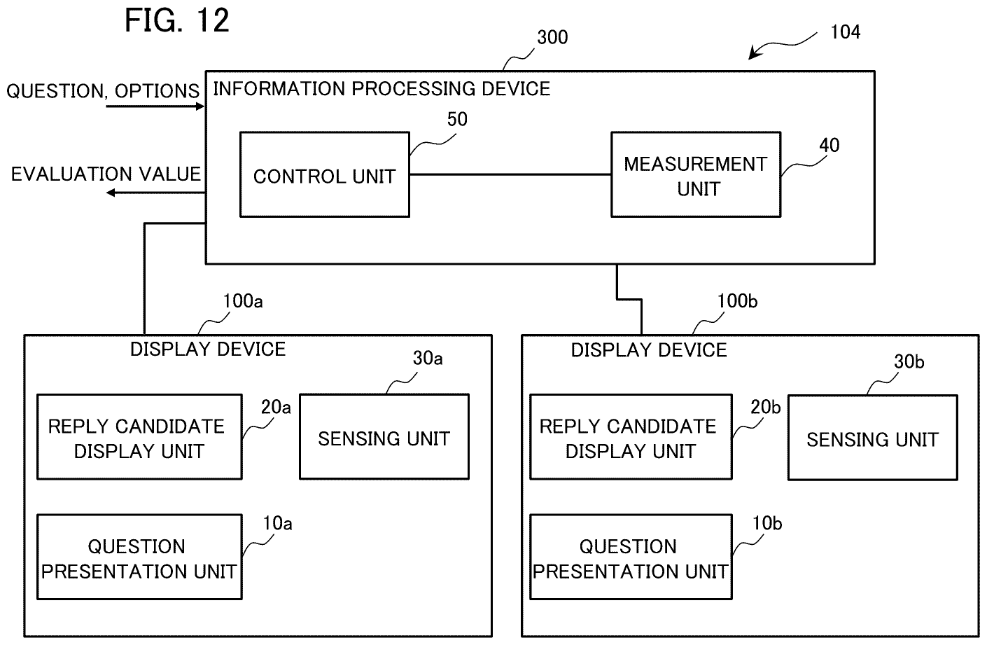

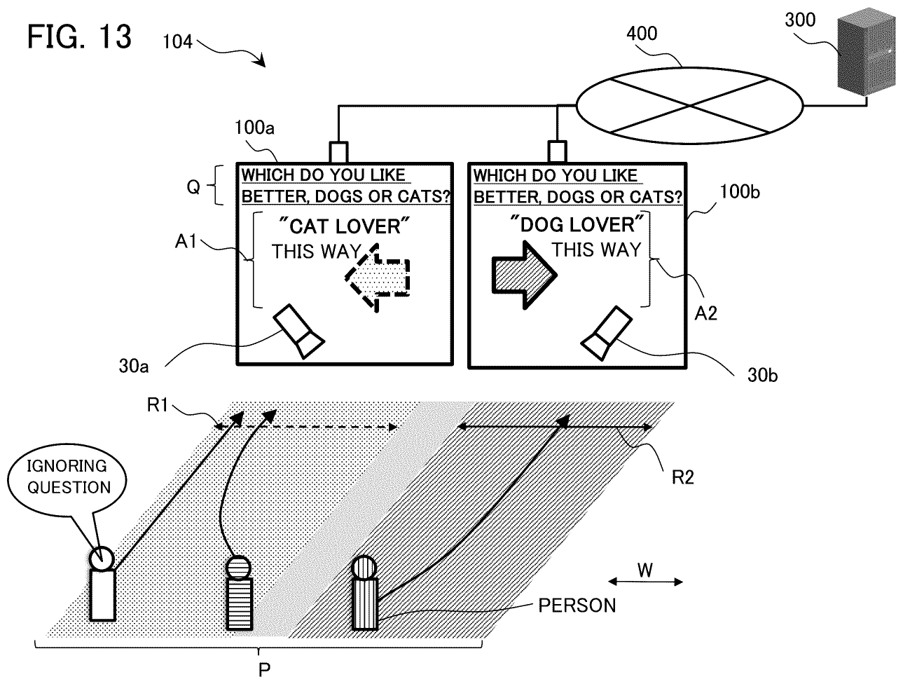

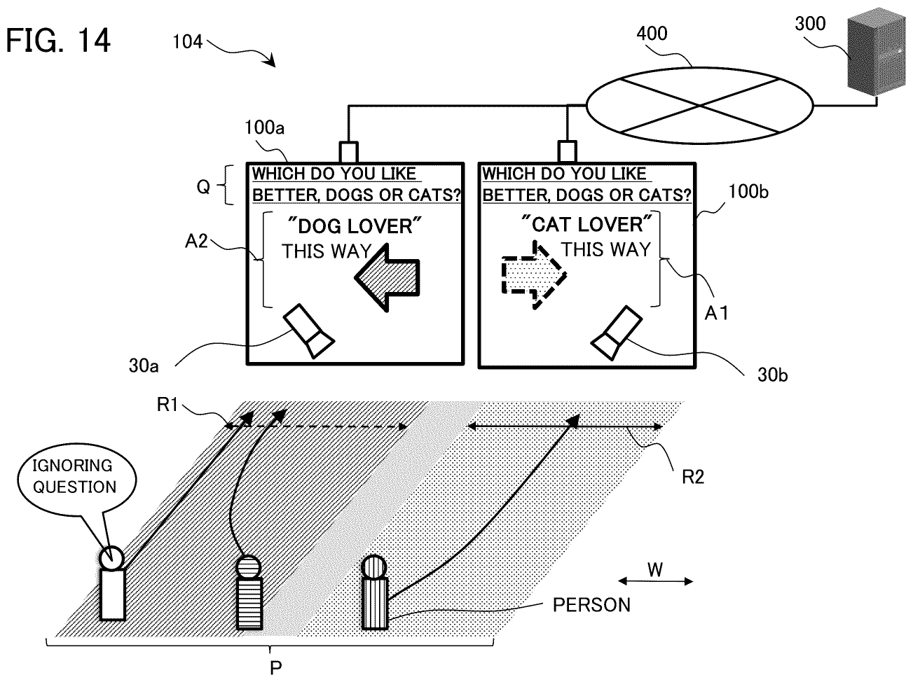

FIG. 12 is a block diagram schematically showing the configuration of an information presentation collection system 104 according to a fourth embodiment. In FIG. 12, each component identical or corresponding to a component shown in FIG. 6 (the second embodiment) is assigned the same reference character as in FIG. 6. FIG. 13 and FIG. 14 are schematic diagrams showing an example of the operation of the information presentation collection system 104. In FIG. 13 and FIG. 14, each component identical or corresponding to a component shown in FIG. 7 or FIG. 8 (the second embodiment) is assigned the same reference character as in FIG. 7 or FIG. 8.

The information presentation collection system 104 includes a plurality of display devices 100a, 100b. The display device 100a includes the question presentation unit 10a that presents (e.g., displays) a question, the reply candidate display unit 20a that displays a reply candidate, and a sensing unit 30a. The display device 100b includes the question presentation unit 10b that presents (e.g., displays) a question, the reply candidate display unit 20b that displays a reply candidate, and a sensing unit 30b. Similarly to the sensing unit 30 in the second embodiment, each of the sensing units 30a, 30b as sensors includes a camera, an object sensor, or both of the camera and the object sensor.

As shown in FIG. 13 and FIG. 14, the information presentation collection system 104 includes the display devices 100a, 100b, and the display devices 100a, 100b display the question Q. The display devices 100a, 100b respectively display the reply candidates A1, A2 in the state of FIG. 13, and the display devices 100a, 100b respectively display the reply candidates A2, A1 in the state of FIG. 14. Further, in the display state of FIG. 13, image capturing ranges of the sensing units 30a, 30b correspond respectively to the regions R1, R2. In the display state of FIG. 14, the image capturing ranges of the sensing units 30a, 30b correspond respectively to the regions R2, R1.

According to the fourth embodiment, the accuracy of the evaluation result in regard to the passersby's replies to the question Q can be increased similarly to the second embodiment. Except for the above-described features, the information presentation collection system 104 is the same as the information presentation collection system 102.

### Fifth Embodiment

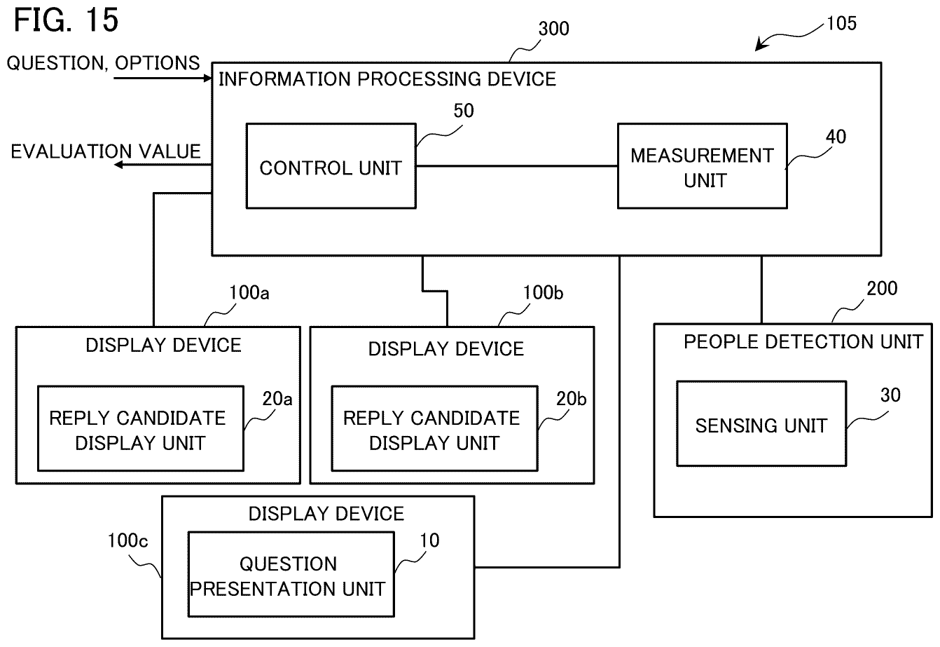

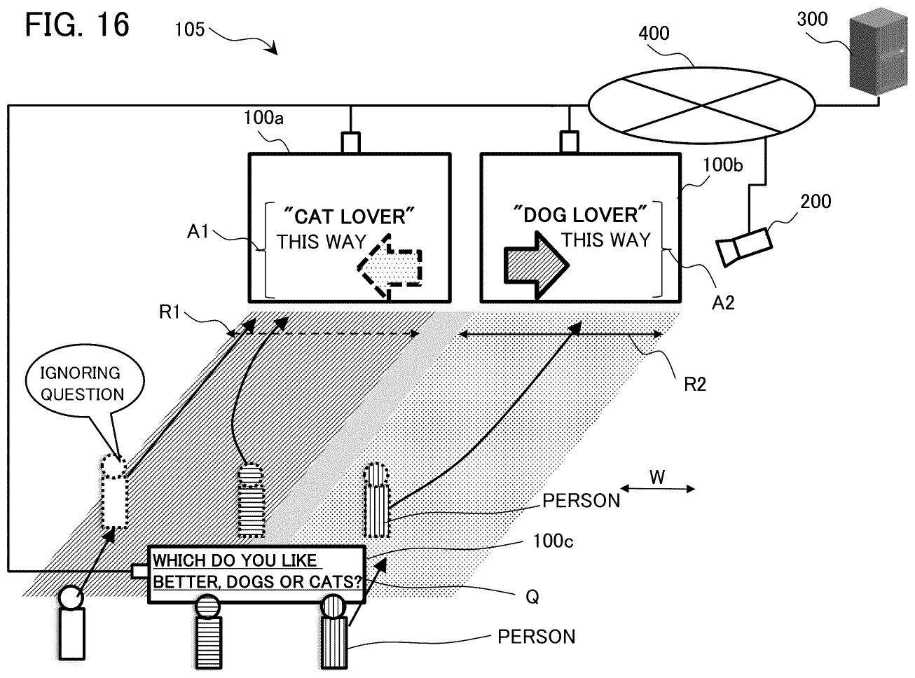

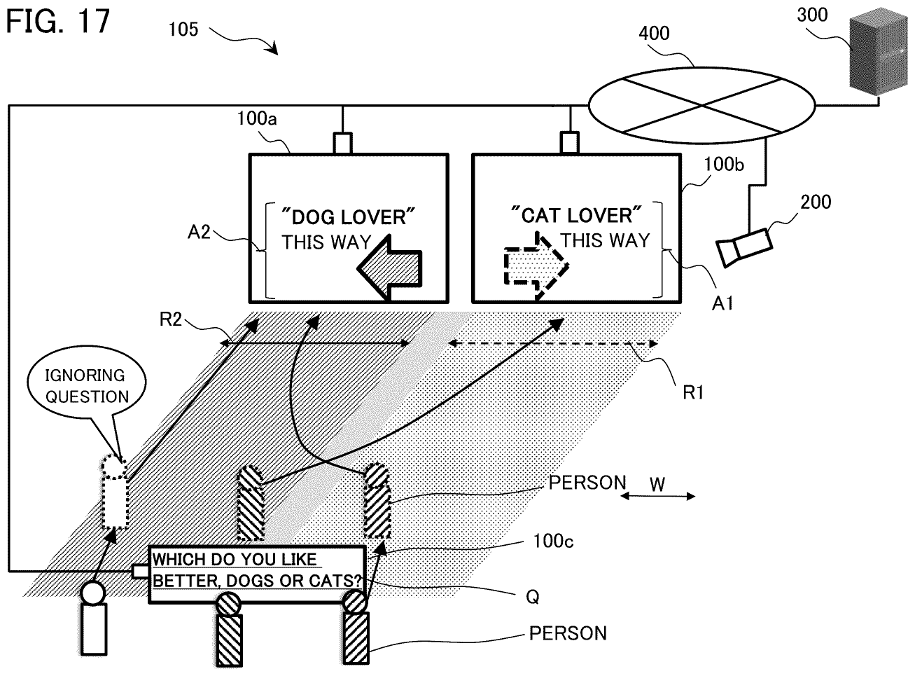

FIG. 15 is a block diagram schematically showing the configuration of an information presentation collection system 105 according to a fifth embodiment. In FIG. 15, each component identical or corresponding to a component shown in FIG. 6 (the second embodiment) is assigned the same reference character as in FIG. 6. FIG. 16 and FIG. 17 are schematic diagrams showing an example of the operation of the information presentation collection system 105. In FIG. 16 and FIG. 17, each component identical or corresponding to a component shown in FIG. 7 or FIG. 8 is assigned the same reference character as in FIG. 7 or FIG. 8 (the second embodiment).

The information presentation collection system 105 includes the display device 100a, the display device 100b and a display device 100c. Each of the display device 100a, the display device 100b and the display device 100c is a liquid crystal display, a projector or the like, for example. The display device 100a includes the reply candidate display unit 20a that displays a reply candidate. The display device 100b includes the reply candidate display unit 20b that displays a reply candidate. The display device 100c includes the question presentation unit 10 that presents (e.g., displays) the question Q. The display device 100c may also present the question Q by means of audio. The sensing unit 30 as a sensor in the fifth embodiment includes a camera, an object sensor, or both of the camera and the object sensor similarly to that in the second embodiment.

As shown in FIG. 16 and FIG. 17, in the information presentation collection system 105, the display device 100c that displays the question Q is arranged on an upstream side in the people's moving direction relative to the display devices 100a, 100b. A person who passed through the position of the display device 100c moves towards the display device 100a or 100b. In the state of FIG. 16, the display devices 100a, 100b respectively display the reply candidates A1, A2, and regions directly under the reply candidates A1, A2 are respectively the regions R1, R2. In the state of FIG. 17, the display devices 100a, 100b respectively display the reply candidates A2, A1, and regions directly under the reply candidates A2, A1 are respectively the regions R2, R1.

According to the fifth embodiment, the accuracy of the evaluation result in regard to the passersby's replies to the question Q can be increased similarly to the second embodiment. Further, according to the fifth embodiment, a person who saw the question Q on the display device 100c is capable of determining the reply and gradually changing the moving direction in a period before reaching the display device 100a or 100b, and thus an abrupt change in the person's moving direction is unlikely to be caused. Accordingly, there is an advantage in that a person advancing to a reply candidate is unlikely to cause obstruction to traffic of other people. Except for the above-described features, the information presentation collection system 105 is the same as the information presentation collection system 102.

### Sixth Embodiment

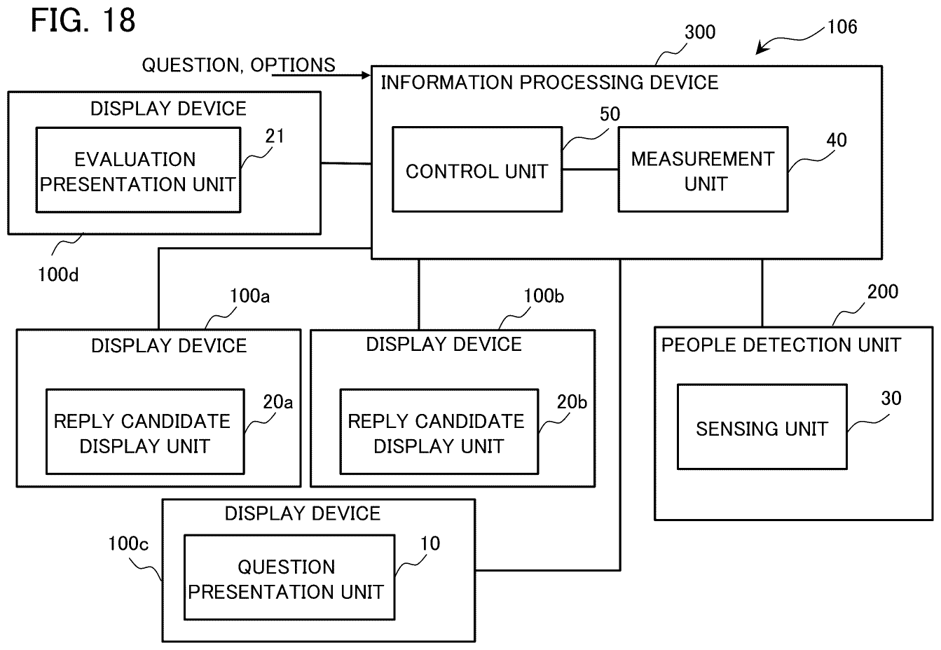

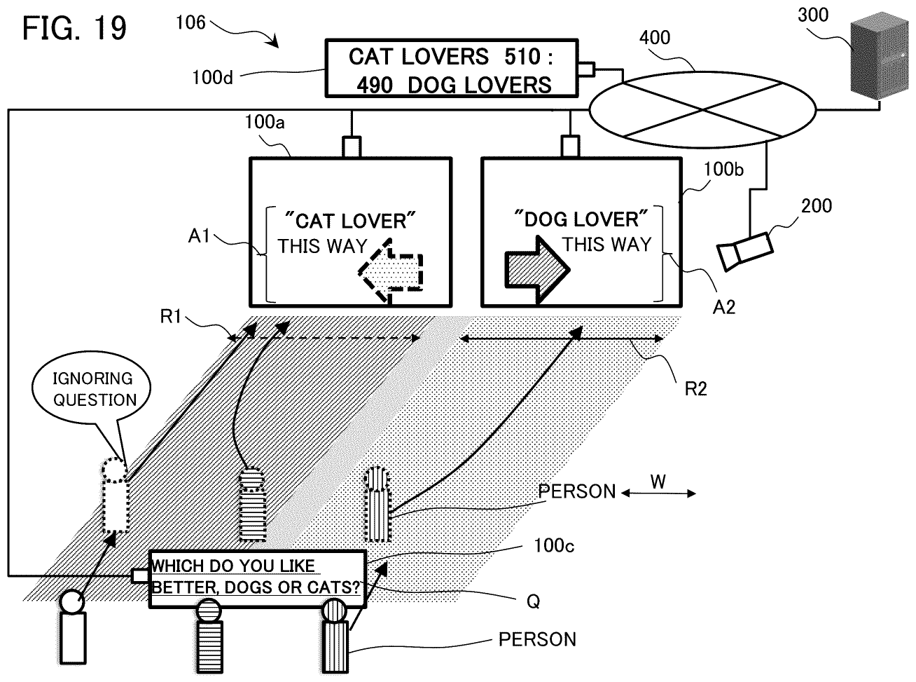

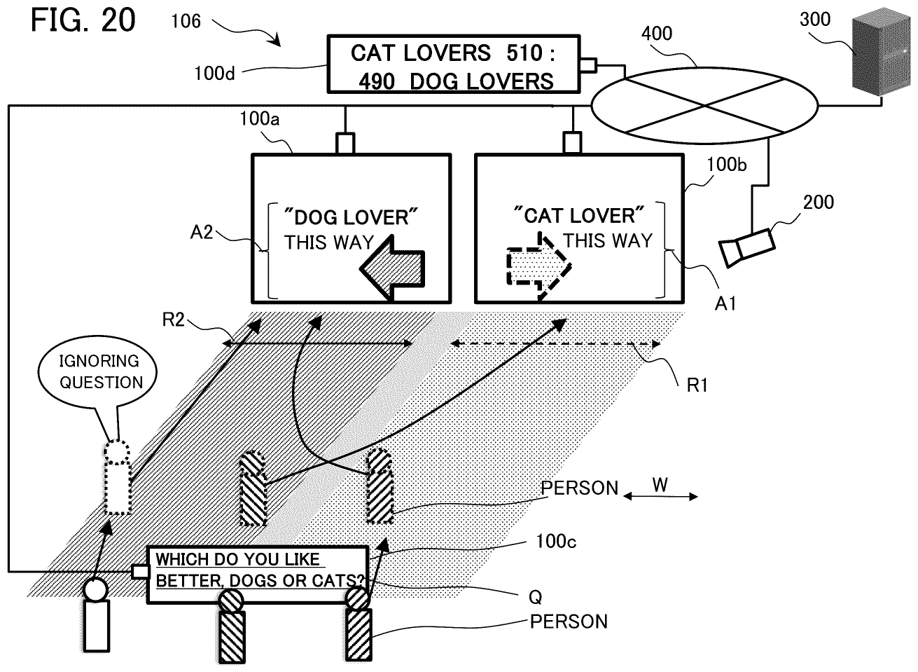

FIG. 18 is a block diagram schematically showing the configuration of an information presentation collection system 106 according to a sixth embodiment. In FIG. 18, each component identical or corresponding to a component shown in FIG. 15 (the fifth embodiment) is assigned the same reference character as in FIG. 15. FIG. 19 and FIG. 20 are schematic diagrams showing an example of the operation of the information presentation collection system 106. In FIG. 19 and FIG. 20, each component identical or corresponding to a component shown in FIG. 16 or FIG. 17 (the fifth embodiment) is assigned the same reference character as in FIG. 16 or FIG. 17.

The information presentation collection system 106 differs from the information presentation collection system 105 in including a display device 100d as an evaluation display device that displays the evaluation value as the result of the evaluation made by the information processing device 300. FIG. 19 shows an example in which the display device 100d is displaying “CAT LOVERS 510:490 DOG LOVERS”. FIG. 20 shows an example in which the display device 100d is displaying “DOG LOVERS 490:510 CAT LOVERS”. Here, “510:490” represents the ratio between the number of passersby who replied “CAT LOVER” per unit time and the number of passersby who replied “DOG LOVER” per unit time.

According to the sixth embodiment, the accuracy of the evaluation result in regard to the passersby's replies to the question Q can be increased similarly to the fifth embodiment. Further, according to the sixth embodiment, the evaluation value regarding the question Q can be seen on the display device 100d, by which the passersby can be made to have an interest in the question Q and the ratio of people cooperating with the replying can be increased. Except for the above-described features, the information presentation collection system 106 is the same as the information presentation collection system 105.

### Seventh Embodiment

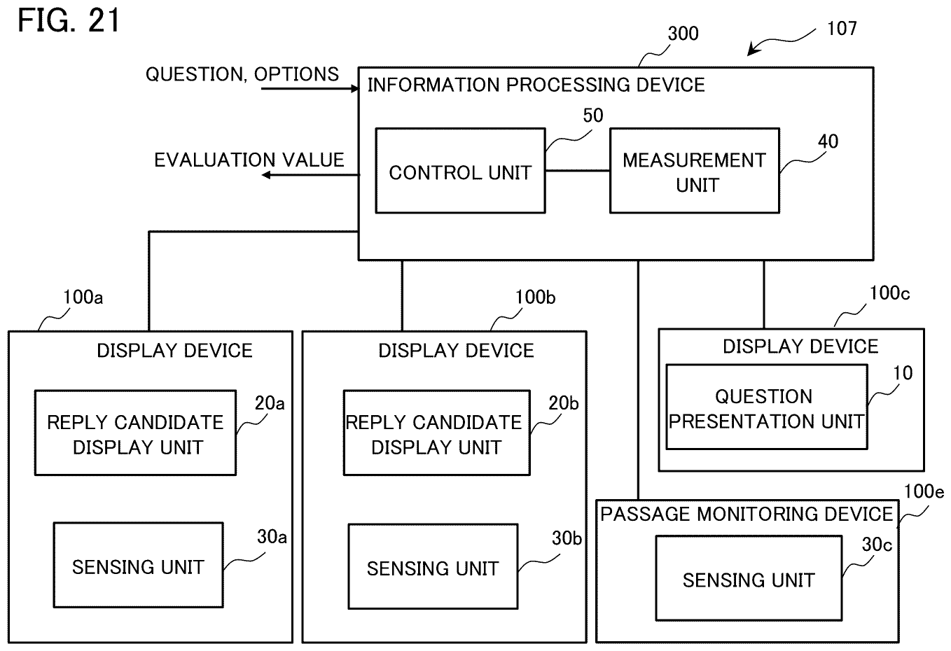

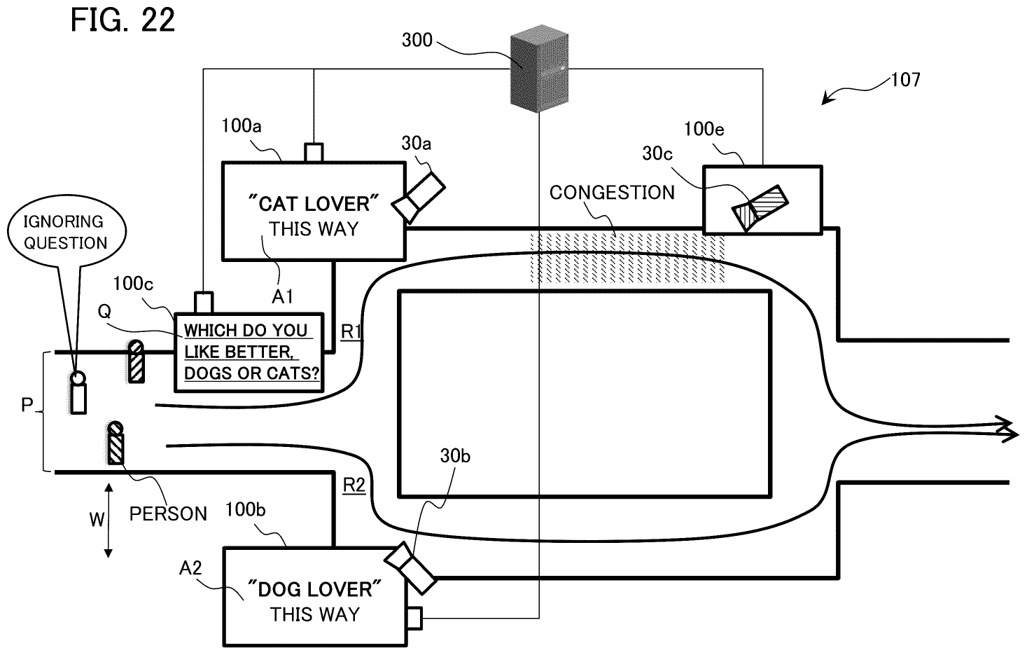

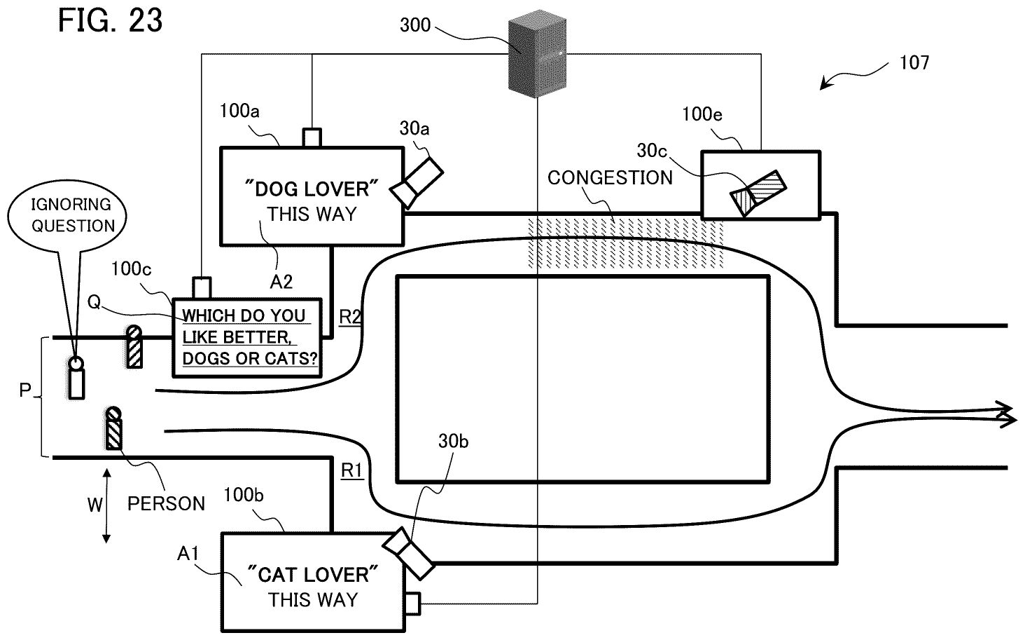

FIG. 21 is a block diagram schematically showing the configuration of an information presentation collection system 107 according to a seventh embodiment. In FIG. 21, each component identical or corresponding to a component shown in FIG. 15 (the fifth embodiment) is assigned the same reference character as in FIG. 15. FIG. 22 and FIG. 23 are schematic diagrams showing an example of the operation of the information presentation collection system 107. In FIG. 22 and FIG. 23, each component identical or corresponding to a component shown in FIG. 16 or FIG. 17 (the fifth embodiment) is assigned the same reference character as in FIG. 16 or FIG. 17.

The information presentation collection system 107 further includes a passage monitoring device 100e that monitors congestion in the passage. The passage monitoring device 100e includes a sensing unit 30c. Further, in the information presentation collection system 107, the display device 100a includes the sensing unit 30a, and the display device 100b includes the sensing unit 30b. The sensing unit 30c as a sensor in the passage monitoring device 100e includes a camera, an object sensor, or both of the camera and the object sensor. The control unit 50 detects the congestion in the passage by analyzing the detection signal from the sensing unit 30c, and when a congestion level exceeds a predetermined set value, changes the display switching schedule of the reply candidates so as to mitigate the congestion.

According to the seventh embodiment, the accuracy of the evaluation result in regard to the passersby's replies to the question Q can be increased similarly to the fifth embodiment. Further, according to the seventh embodiment, when one of two passages after a branch point is congested with people, it is possible to set a schedule for mitigating the congestion, that is, it is possible to display the reply candidates so as not to guide people to the congested area. In such cases, it is also possible to temporarily interrupt the collecting of the reply information. Except for the above-described features, the information presentation collection system 107 is the same as the information presentation collection system 105.

### Eighth Embodiment

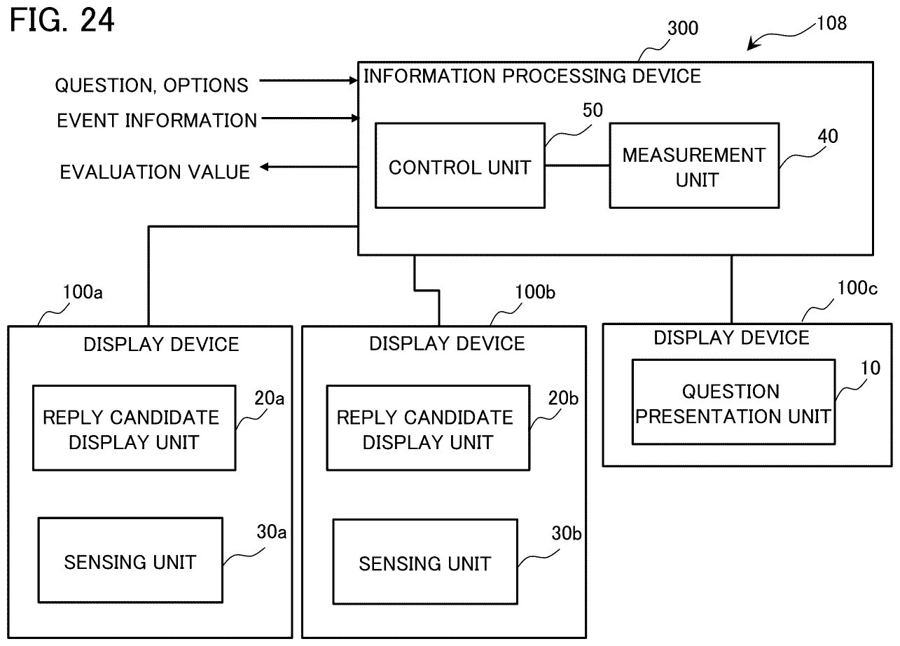

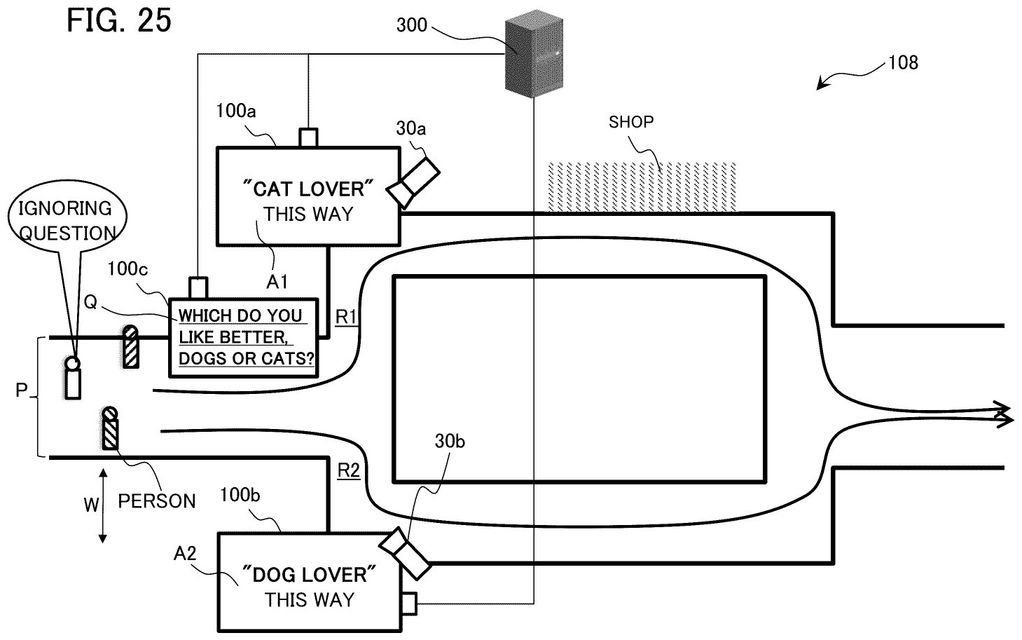

FIG. 24 is a block diagram schematically showing the configuration of an information presentation collection system 108 according to an eighth embodiment. In FIG. 24, each component identical or corresponding to a component shown in FIG. 21 (the seventh embodiment) is assigned the same reference character as in FIG. 21. FIG. 25 is a schematic diagram showing an example of the operation of the information presentation collection system 108. In FIG. 25, each component identical or corresponding to a component shown in FIG. 22 (the seventh embodiment) is assigned the same reference character as in FIG. 22.

The information presentation collection system 108 has a function of previously acquiring schedule information regarding an event to be held in the passage (i.e., in the passage or an area facing the passage) such as a limited time offer (i.e., discount sale for a limited time slot) held by a shop facing the passage P and changing the schedule so as to increase the number of people guided to the place where the event is currently held.

According to the eighth embodiment, the accuracy of the evaluation result in regard to the passersby's replies to the question Q can be increased similarly to the seventh embodiment. Further, according to the eighth embodiment, it is possible to set a schedule for guiding a lot of people to the passage where an event is currently held and display the reply candidates accordingly. In such cases, it is also possible to temporarily interrupt the collecting of the reply information. Except for the above-described features, the information presentation collection system 108 is the same as the information presentation collection system 107.

### Ninth Embodiment

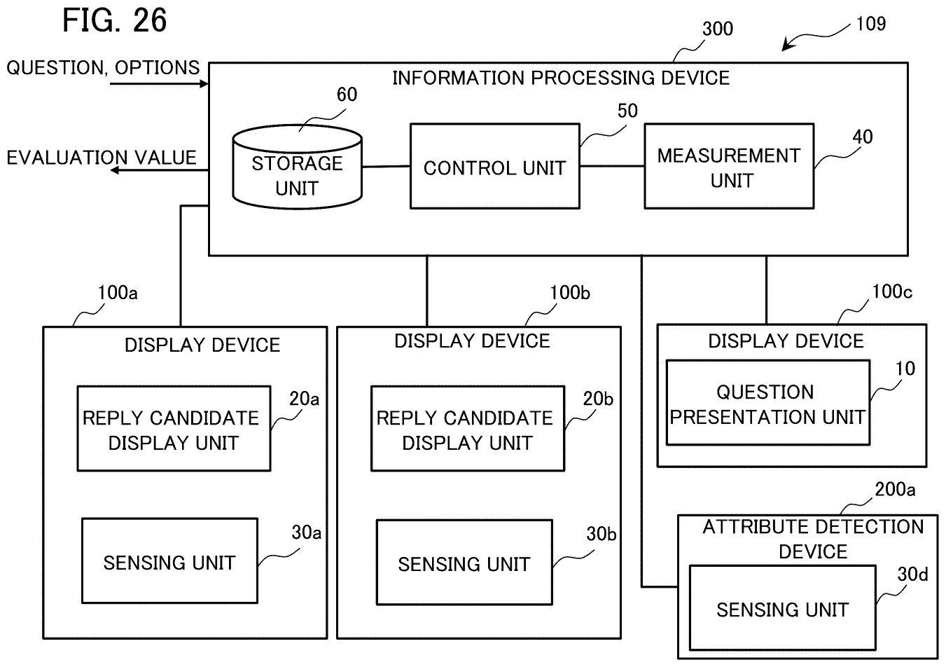

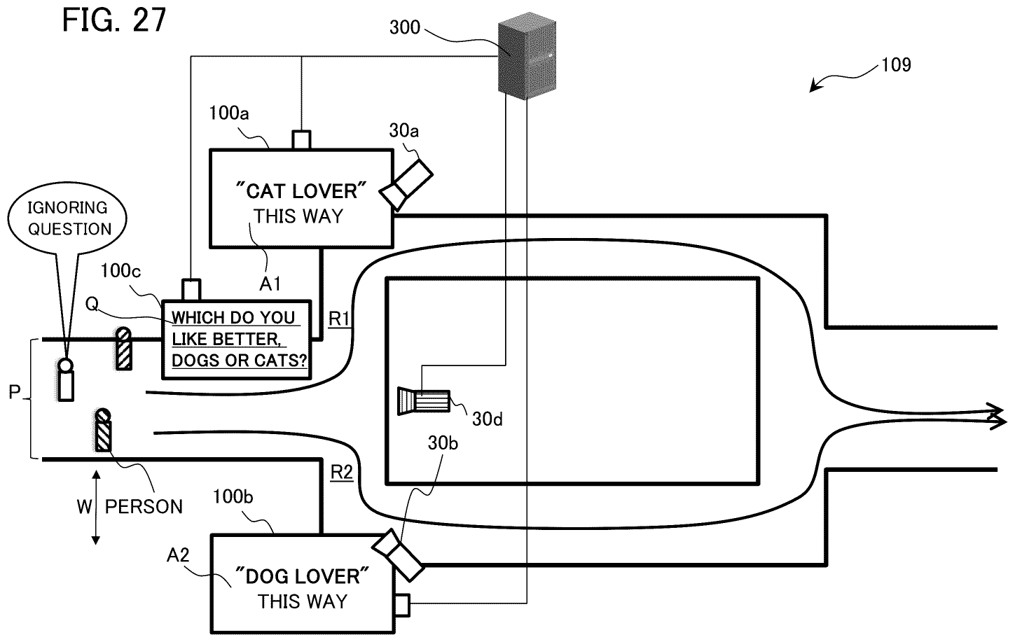

FIG. 26 is a block diagram schematically showing the configuration of an information presentation collection system 109 according to a ninth embodiment. In FIG. 26, each component identical or corresponding to a component shown in FIG. 21 (the seventh embodiment) is assigned the same reference character as in FIG. 21. FIG. 27 is a schematic diagram showing an example of the operation of the information presentation collection system 109. In FIG. 27, each component identical or corresponding to a component shown in FIG. 22 (the seventh embodiment) is assigned the same reference character as in FIG. 22.

The information presentation collection system 109 includes an attribute detection device (i.e., an attribute detector) 200a for detecting an attribute of the people moving in the passage P. The attribute detection device 200a includes a sensing unit 30d. The sensing unit 30d is a sensor (i.e., sensor device) which includes a camera, an object sensor, or both of the camera and the object sensor. The attribute detection device 200a detects an attribute of the moving people based on an image captured by the sensing unit 30d, for example, and the control unit 50 has a function of changing the schedule so as to guide a lot of people to one of the passages based on the attribute. The attribute is, for example, one or more out of a person's sex, age (e.g., age group), body form (e.g., body height), cloths, etc.

For example, when there is a clothing shop for females beside one of two passages after a branch point and the attribute detection device 200a frequently detects “female” as the attribute of the people (detects females at a ratio higher than or equal to a predetermined threshold value), the control unit 50 can set the schedule of the switching of the reply candidates so as to guide people to the passage beside which the clothing shop for females is situated.

According to the ninth embodiment, the accuracy of the evaluation result in regard to the passersby's replies to the question Q can be increased similarly to the seventh embodiment. Further, according to the ninth embodiment, it is possible to provide the system with the function of making the arrangement of the reply candidates suitable for the attribute of the people and thereby guiding the people. In such cases, it is also possible to temporarily interrupt the collecting of the reply information. Except for the above-described features, the information presentation collection system 109 is the same as the information presentation collection system 107.

### Tenth Embodiment

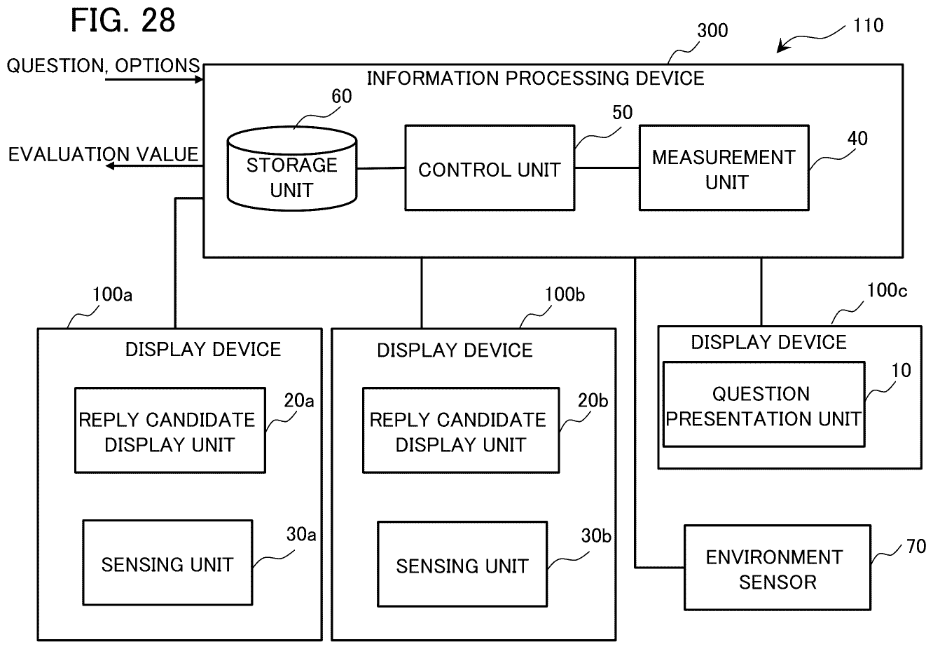

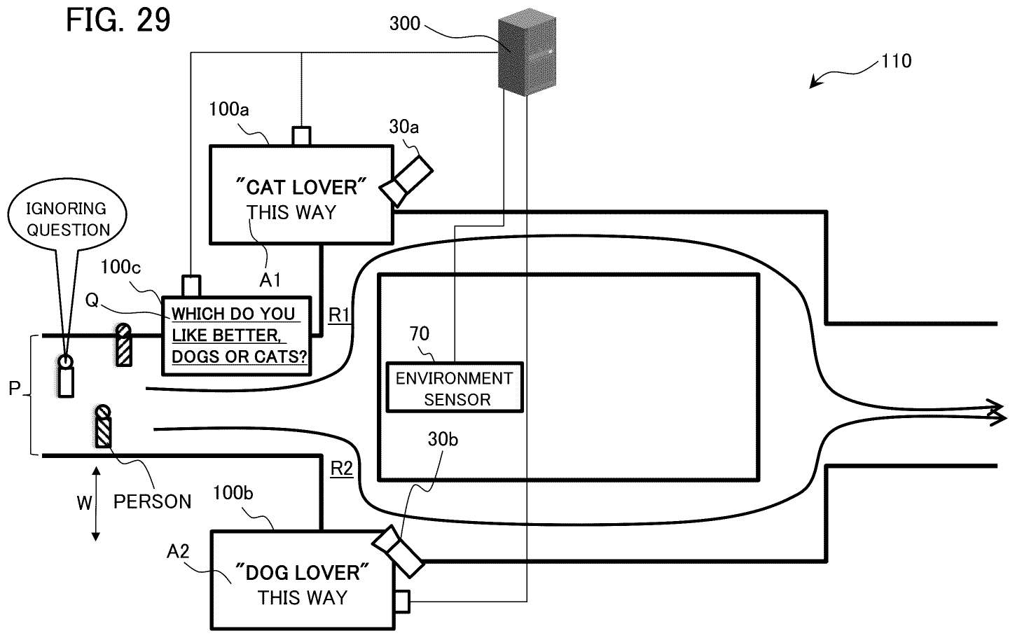

FIG. 28 is a block diagram schematically showing the configuration of an information presentation collection system 110 according to a tenth embodiment. In FIG. 28, each component identical or corresponding to a component shown in FIG. 21 (the seventh embodiment) is assigned the same reference character as in FIG. 21. FIG. 29 is a schematic diagram showing an example of the operation of the information presentation collection system 110. In FIG. 29, each component identical or corresponding to a component shown in FIG. 22 (the seventh embodiment) is assigned the same reference character as in FIG. 22.

The information presentation collection system 110 includes an environment sensor 70, and the control unit 50 sets the schedule based on a detection value from the environment sensor 70. The environment sensor 70 detects at least one of temperature, humidity, wind volume, a wind direction and weather. It is also possible for the environment sensor 70 to acquire (e.g., receive) information regarding at least one of the temperature, the humidity, the wind volume, the wind direction and the weather from another device.

For example, when one of two passages after a branch point is an outdoor passage, the other passage is an indoor passage, and the environment sensor 70 has detected bad weather (raining, strong wind, or the like), the control unit 50 can set the schedule of the switching of the reply candidates so as to guide people to the indoor passage.

For example, when there is a shop selling beverages in one of two passages after a branch point and the environment sensor 70 has detected high temperature, the control unit 50 can set the schedule of the switching of the reply candidates so as to guide people to the passage where the shop selling beverages is situated. According to the tenth embodiment, the accuracy of the evaluation result in regard to the passersby's replies to the question Q can be increased similarly to the seventh embodiment. Further, according to the tenth embodiment, it is possible to set a schedule for guiding people based on the detection value from the environment sensor 70. In such cases, it is also possible to temporarily interrupt the collecting of the reply information. Except for the above-described features, the information presentation collection system 110 is the same as the information presentation collection system 107.

### Modifications

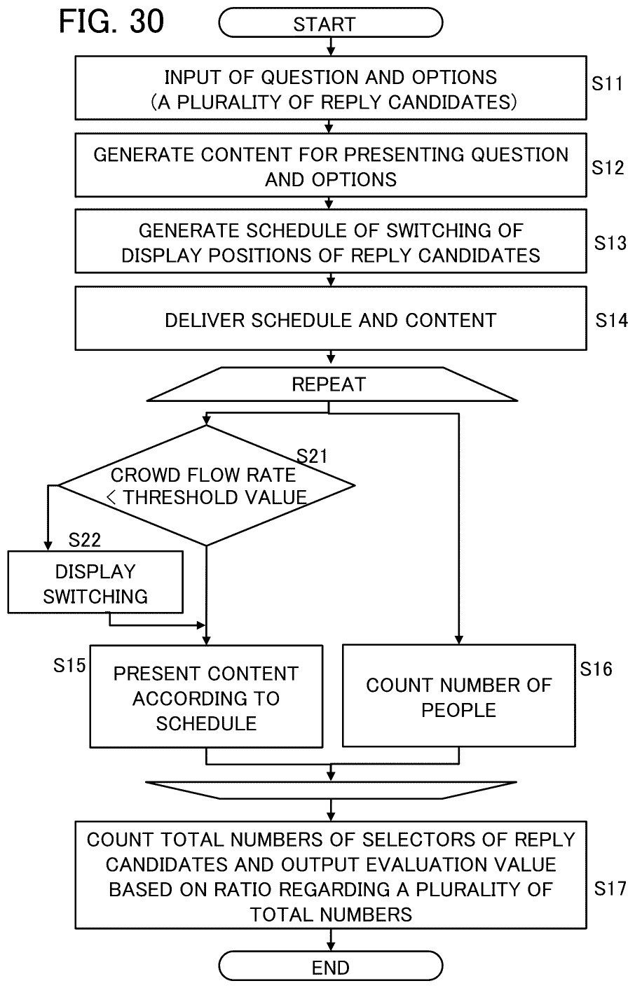

FIG. 30 is a flowchart showing the operation of an information presentation collection system in a modification of the first to tenth embodiments. In FIG. 30, each step being the same as a step shown in FIG. 5 is assigned the same reference character as in FIG. 5. In the process in FIG. 30, when a crowd flow rate based on the detection signal from the sensing unit (e.g., the sensing unit 30 in FIG. 1, the sensing unit 30d in FIG. 27, or the like) is less than a predetermined threshold value (YES in step S21), the control unit 50 executes the display switching of the reply candidate display units 20a, 20b (step S22). By this process, it is possible to prevent the display switching from adversely affecting the passersby (e.g., causing an abrupt change in the moving direction). Except for these features, the information presentation collection system in the modification is the same as the information presentation collection system in any one of the above-described first to tenth embodiments.

Further, in the above-described systems, in the calculation of the total numbers N1, N2, records of replies with each reply candidate may be added up together with past results.

Furthermore, in the above-described systems, it is also possible to calculate the number of people who replied and the number of people who did not reply in addition to the total numbers N1, N2.

Moreover, in the above-described systems, it is also possible to discard data in a predetermined period immediately after, or before and after, the display switching of the reply candidates. This is because there is a high probability that a replier is passing through an unintended region in this period.

### Description of Reference Characters

10, 10a, 10b: question presentation unit, 20, 20a, 20b: reply candidate display unit, 30, 30a, 30b, 30c, 30d: sensing unit, 40: measurement unit, 50: control unit, 60: storage unit, 70: environment sensor, 100, 100a, 100b, 100c, 100d: display device, 101-110: information presentation collection system, 120a, 120b: display control device, 200: people detection unit, 200a: attribute detection device, 300: information processing device, 400: network, Q: question, A1, A2: reply candidate, P: passage, R1, R2: region, W: width direction.

What is claimed is:

1. An information presentation collection system comprising:
a question display device to present a question;
a reply candidate display device to display a plurality of reply candidates, as options for a reply to the question, at display positions different from each other in a width direction of a passage;
at least one of sensors to detect people moving in the passage and to output a detection signal; and
processing circuitry
to measure a number of the people moving in a direction towards the reply candidate display device in each of a plurality of regions, which are set by dividing the passage in the width direction of the passage and corresponding respectively to the plurality of reply candidates, based on the detection signal; and
to control operation of the information presentation collection system,
wherein the processing circuitry
repeatedly performs display switching of switching the display positions of the plurality of reply candidates to each other according to a predetermined schedule,
counts a total number of people who selected each of the plurality of reply candidates in a plurality of information collection periods based on the number of the people measured in each information collection period from one of the display switchings to the next display switching, and
outputs a value based on a ratio regarding a plurality of the total numbers as an evaluation value.

2. The information presentation collection system according to claim 1, wherein a display device that includes the question display device and the reply candidate display device.

3. The information presentation collection system according to claim 1, comprising a plurality of display devices,
wherein the plurality of display devices respectively display the plurality of reply candidates.

4. The information presentation collection system according to claim 1, comprising a plurality of display devices, wherein
the plurality of display devices display the question, and
the plurality of display devices respectively display the plurality of reply candidates.

5. The information presentation collection system according to claim 3, wherein
the at least one of sensors includes a plurality of sensors, and
the plurality of display devices respectively include the plurality of sensors.

6. The information presentation collection system according to claim 1, comprising a plurality of display devices, wherein
one display device among the plurality of display devices is the question display device and displays the question, and
other display devices among the plurality of display devices are the reply candidate display devices and respectively display the plurality of reply candidates.

7. The information presentation collection system according to claim 1, comprising an evaluation display device to display the evaluation value.

8. The information presentation collection system according to claim 1, further comprising a passage monitoring device to monitor congestion in the passage,
wherein the processing circuitry sets the schedule so as to mitigate the congestion.

9. The information presentation collection system according to claim 1, wherein the processing circuitry previously acquires schedule information regarding an event to be held in the passage and sets the schedule so as to increase the number of the people guided to a place where the event is currently held.

10. The information presentation collection system according to claim 1, further comprising an attribute detector to detect an attribute of people advancing in the passage,
wherein the processing circuitry sets the schedule based on the attribute.

11. The information presentation collection system according to claim 1, further comprising an environment sensor to detect at least one of temperature, humidity, wind volume, a wind direction and weather,
wherein the processing circuitry sets the schedule based on a detection value from the environment sensor.

12. The information presentation collection system according to claim 2, wherein the processing circuitry is provided in a vicinity of or inside the display device.

13. The information presentation collection system according to claim 1, wherein the processing circuitry is arranged in a vicinity of or inside the question display device or the reply candidate display device.

14. The information presentation collection system according to claim 1, wherein the processing circuitry performs the display switching of the reply candidates when a crowd flow rate based on the detection signal from the at least one of sensors is less than a predetermined threshold value.

15. The information presentation collection system according to claim 1, wherein the sensor includes at least one of a camera and an object sensor arranged in the passage.

16. An information presentation collection method to be executed by an information processing device in an information presentation collection system including a question display device to present a question, a reply candidate display device to display a plurality of reply candidates, as options for a reply to the question, at display positions different from each other in a width direction of a passage, a sensor to detect people moving in the passage and outputs a detection signal, and the information processing device, the method comprising:
measuring a number of the people moving in a direction towards the reply candidate display device in each of a plurality of regions, which are set by dividing the passage in the width direction of the passage and corresponding respectively to the plurality of reply candidates, based on the detection signal;
repeatedly performing display switching of switching the display positions of the plurality of reply candidates to each other according to a predetermined schedule;
counting a total number of people who selected each of the plurality of reply candidates in a plurality of information collection periods based on the number of the people measured in each information collection period from one of the display switchings to the next display switching; and
outputting a value based on a ratio regarding a plurality of the total numbers as an evaluation value.

17. A non-transitory computer-readable record medium storing an information presentation collection program to be executed by an information processing device in an information presentation collection system including a question display device to present a question, a reply candidate display device to display a plurality of reply candidates, as options for a reply to the question, at display positions different from each other in a width direction of a passage, a sensor to detect people moving in the passage and outputs a detection signal, and the information processing device, wherein the information presentation collection program causes the information processing device to execute:
measuring a number of the people moving in a direction towards the reply candidate display device in each of a plurality of regions, which are set by dividing the passage in the width direction of the passage and corresponding respectively to the plurality of reply candidates, based on the detection signal;
repeatedly performing display switching of switching the display positions of the plurality of reply candidates to each other according to a predetermined schedule;
counting a total number of people who selected each of the plurality of reply candidates in a plurality of information collection periods based on the number of the people measured in each information collection period from one of the display switchings to the next display switching; and
outputting a value based on a ratio regarding a plurality of the total numbers as an evaluation value.
